(19) United States
(12) Patent Application Publication
(10) Pub. No.: US 2025/0236040 A1
(43) Pub. Date: Jul. 24, 2025

(54) SLICING MACHINES, CUTTING STATIONS THEREFOR, AND METHODS OF USE

(71) Applicant: Urschel Laboratories, Inc., Chesterton, IN (US)

(72) Inventors: Brandon Kretchmer, Griffith, IN (US); Scot Alan Klockow, Kouts, IN (US)

(21) Appl. No.: 19/025,106

(22) Filed: Jan. 16, 2025

Related U.S. Application Data
(60) Provisional application No. 63/623,980, filed on Jan. 23, 2024.

(51) Int. Cl. B26D 7/26; B26D 7/06

(52) U.S. Cl. CPC B26D 7/2614; B26D 7/0691; B26D 2210/02

(57) ABSTRACT

Cutting stations for slicing machines and slicing machines equipped therewith. Such a cutting station includes a knife holder, a strip-cut knife supported on the knife holder, and a clamp that clamps the knife to the knife holder. The strip-cut knife has a cutting edge that protrudes from a leading edge of the knife holder and tab blades that are oriented perpendicular to the cutting edge. A gate is disposed in proximity of the knife holder and the cutting edge of the strip-cut knife. The gate has a trailing end that, with the cutting edge of strip-cut knife, defines a gate opening that determines the thickness of a slice produced by the cutting station. The trailing end of the gate has gate slots defined therein in which the tab blades are received.

### CROSS-REFERENCE TO RELATED APPLICATIONS

The application claims the benefit of U.S. Provisional Application No. 63/623,980 filed Jan. 23, 2024, the contents of which are incorporated herein by reference.

### BACKGROUND OF THE INVENTION

The present invention generally relates to machines for cutting products, including but not limited to slicing products. The invention particularly relates to slicing machines configured for cutting food products into strips.

Various types of equipment are known for slicing, shredding and granulating food products, as nonlimiting examples, vegetables, fruits, dairy products, and meat products. Widely used machines for this purpose are commercially available from Urschel Laboratories, Inc., and include machines under the name Model CC7. The Model CC7 machines are centrifugal-type slicers capable of slicing a wide variety of products at high production capacities. The Model CC7 line of machines is particularly adapted to produce uniform slices, strip cuts, shreds, and granulations. Certain configurations and aspects of Model CC7 machines are represented in U.S. Pat. Nos. 3,139,128, 3,139,129, 5,694,824, 6,968,765, 7,658,133, 8,161,856, 9,193,086, 10,456,943, 10,562,203, 10,632,639, 10,933,552, and 11,034,043 and U.S. Patent Application Publication No. 2022/0402159, the entire contents of which are incorporated herein by reference.

FIG. 1 schematically represents a cross-sectional view of a machine 10 that is representative of a Model CC7 machine. The machine 10 includes a generally annular-shaped cutting head 12 and an impeller 14 coaxially mounted within the cutting head 12. The impeller 14 has an axis 17 of rotation that coincides with the center axis of the cutting head 12, and is rotationally driven about its axis 17 through a shaft (not shown) that is enclosed within a housing 18 and coupled to a gear box 16. The cutting head 12 is mounted on a support ring 15 above the gear box 16 and remains stationary as the impeller 14 rotates. Products are delivered to the cutting head 12 and impeller 14 through a feed hopper 11 located above the impeller 14. In operation, as the hopper 11 delivers products to the impeller 14, centrifugal forces cause the products to move outward into engagement with cutting knives (not shown) that are mounted along the circumference of the cutting head 12. The impeller 14 comprises generally radially oriented paddles 13, each having a face that engages and directs the products radially outward toward and against the knives of the cutting head 12 as the impeller 14 rotates. Other aspects pertaining to the construction and operation of Model CC7 machines, including various embodiments thereof, can be appreciated from the aforementioned prior patent documents incorporated herein by reference.

FIG. 2 is an isolated view of a particular but nonlimiting example of a cutting head 12 that has been used with Model CC7 slicing machines, including the machine 10 schematically represented in FIG. 1. The cutting head 12 represented in FIG. 2 will be described hereinafter in reference to the machine 10 of FIG. 1 equipped with an impeller 14 as described in reference to FIG. 1. On the basis of the coaxial arrangement of the cutting head 12 and the impeller 14, relative terms including but not limited to Aaxial, @ Acircumferential, @ Aradial, @ etc., and related forms thereof may be used below to describe the cutting head 12 represented in FIG. 2.

In FIG. 2, the cutting head 12 can be seen as generally annular-shaped with cutting knives 20 mounted and circumferentially spaced apart along its perimeter. Each knife 20 projects radially inward in a direction generally opposite the direction of rotation of the impeller 14 within the cutting head 12, and the leading edge of each knife 20 defines a cutting edge at the innermost radial extremity of the knife 20. The cutting head 12 further comprises lower and upper support members, represented in FIG. 2 as rings 22 and ring 24, to and between which circumferentially-spaced cutting stations 26 are secured with fasteners 34.

The knives 20 of the cutting head 12 are represented in FIG. 2 as being individually secured with clamping assemblies 28 to their respective cutting stations 26. Each clamping assembly 28 includes a knife holder 30 mounted to a cutting station 26 and between the support rings 22 and 24, and a clamp 32 positioned on the radially outward-facing side of the holder 30 to secure a knife 20 thereto. Each knife 20 is supported by a radially outer surface of one of the knife holders 30, and the corresponding clamp 32 overlies the holder 30 so that the knife 20 is between the outer surface of the holder 30 and a radially inward surface of the clamp 32 that faces the holder 30. By forcing the clamp 32 toward the holder 30, for example, with an eccentric cam rod 36, the clamp 32 applies a clamping force to the knife 20 adjacent its cutting edge. As an alternative to the use of eccentric cam rods 36, bolts can be used to apply the clamping force to the clamps 32.

FIG. 2 further shows each cutting station 26 as comprising a gate 38 secured to each cutting station 26. A food product crosses the inward-facing surface of the gate 38 prior to encountering the knife 20 mounted to the succeeding cutting station 26, and together the cutting edge of a knife 20 and a trailing edge of the preceding gate 38 define a gate opening 40 that determines the thickness of a slice produced by the knife 20.

FIG. 2 represents the knives 20 as having straight cutting edges for producing flat slices, and as such may be referred to herein as Aflat@ knives, though the cutting head 12 can use knives of other shapes. As a nonlimiting example, the cutting head 12 may be configured to use Ashaped@ knives, including but not limited to knives characterized by a periodic pattern of alternating peaks and valleys when viewed edgewise, to produce corrugated, strip-cut, shredded, and granulated products. As another nonlimiting example, the cutting head 12 may be configured to use knives developed to produce what is known as a strip or julienne cut. Such a cut generally results in a product being cut into long strips. Nonlimiting examples of julienne-type knives are disclosed in U.S. Pat. Nos. 3,395,742, 9,469,041, 9,840,015, 9,849,600, and 10,843,363 and U.S. Patent Application Publication No. 2022/0402159, each of which may be used in various machines including the aforementioned Urschel Model CC7 machines. As defined herein, a strip-cut (or julienne-type) knife may be flat or shaped, but with the further inclusion of julienne “tab” blades spaced along the knife at or adjacent its cutting edge and projecting out of the plane of the knife to produce a desired strip/julienne cross section. FIG. 3 represents a nonlimiting example of a flat strip-cut knife 20 created as an assembly that comprises a flat (planar) slicing knife 20A that defines a cutting edge 42, and a second knife 20B (referred to herein as a julienne or strip knife) that has a flat base 44 and individual julienne tab blades 46 that are oriented roughly perpendicular to the base 44 and, when the slicing knife 20A and strip knife 20B are assembled as shown, are oriented roughly perpendicular to the cutting edge 42 of the slicing knife 20A to produce strip-cut (julienne-cut) flat food products. The tab blades 46 are represented as set back from the cutting edge 42 of the slicing knife 20A, with each tab blade 46 defining a cutting edge 48. In use, the cutting edge 42 of the slicing knife 20A cuts a slice off of a product, immediately followed by the tab blades 46 that cut the slice into strips. The knife 20 depicted in FIG. 3 is representative of what is referred to herein as a handleless knife due to the lack of a handle extending from one of the longitudinal ends of the knife 20, though it is also foreseeable that the knife 20 could be configured as a one-piece knife with a handle that protrudes through an opening in the upper support ring 24, as nonlimiting examples, one-piece knives disclosed in U.S. Patent Application Publication No. 2022/0402159.

While centrifugal-type slicers of the type represented by the Model CC7 have performed extremely well for their intended purposes, further improvements are continuously desired and sought, a nonlimiting example being the completeness of strip cuts when processing certain food products that are difficult to cut into strips at high production rates.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, slicing machines configured for cutting food products into strips.

According to an aspect of the invention, a cutting station for a slicing machine is provided. The cutting station includes a knife holder having a surface and a leading edge, and a strip-cut knife supported on the surface of the knife holder. The strip-cut knife has a cutting edge that protrudes from the leading edge of the knife holder and tab blades that are oriented perpendicular to the cutting edge of the strip-cut knife. A clamp is arranged relative to the knife holder and knife to clamp the knife to the knife holder. The clamp has a leading edge, a trailing edge, a knife-engaging portion adjacent the leading edge of the clamp, and a base portion adjacent the trailing edge of the clamp. At least part of the knife-engaging portion has a shape complementary to the knife. A gate is disposed in proximity of the knife holder and the cutting edge of the strip-cut knife. The gate has a trailing end that, with the cutting edge of the strip-cut knife, defines a gate opening that determines the thickness of a slice produced by the cutting station. The trailing end of the gate has gate slots defined therein in which the tab blades are received. Means is provided for applying a clamping load to the clamp to secure the knife to the knife holder.

According to other aspects of the invention, slicing machines are provided that are equipped with a cutting station as described above, and methods are provided for operating such a slicing machine.

Technical effects of slicing machines having features as described above include the ability to make complete strip cuts in certain food products that may be difficult to cut into strips at high production rates.

Other aspects and advantages of this invention will be appreciated from the following detailed description.

### BRIEF DESCRIPTION OF THE DRAWINGS

FIG. 1 schematically represents a side view in partial cross-section of a centrifugal-type slicing machine known in the art.

FIG. 2 is a perspective view representing details of a cutting head that has found use in slicing machines of the type represented in FIG. 1.

FIG. 3 schematically represents a perspective view of a strip-cut knife known in the art and capable of use in slicing machines of the type represented in FIGS. 1 and 2.

FIG. 4 is a fragmentary perspective view of a cutting head of a slicing machine, such as but not limited to the slicing machine of FIG. 1, and represents two cutting stations installed on the cutting head, each cutting station comprising a knife holder, a clamp, a handled strip-cut knife, a gate, and an eccentric cam rod, and shows each cutting station in a locked (clamping) position in which the eccentric cam rod clamps the knife between the knife holder and clamp.

FIG. 5 is a fragmentary side view of the cutting head and cutting stations of FIG. 4.

FIGS. 6A and 6B are fragmentary cross-sectional views of the cutting stations of FIGS. 4 and 5 and show a clamping assembly of one of the cutting stations in a knife release position and a clamping position, respectively.

FIGS. 7 and 8 are plan and end views, respectively, showing in isolation a gate of FIGS. 4, 5, and 6.

### DETAILED DESCRIPTION OF THE INVENTION

The intended purpose of the following detailed description of the invention and the phraseology and terminology employed therein is to describe what is shown in the drawings, which include the depiction of one or more nonlimiting embodiments of the invention, and to describe certain but not all aspects of what is depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to recite what are believed to be aspects of the invention, including certain but not necessarily all of the aspects and alternatives described in the detailed description.

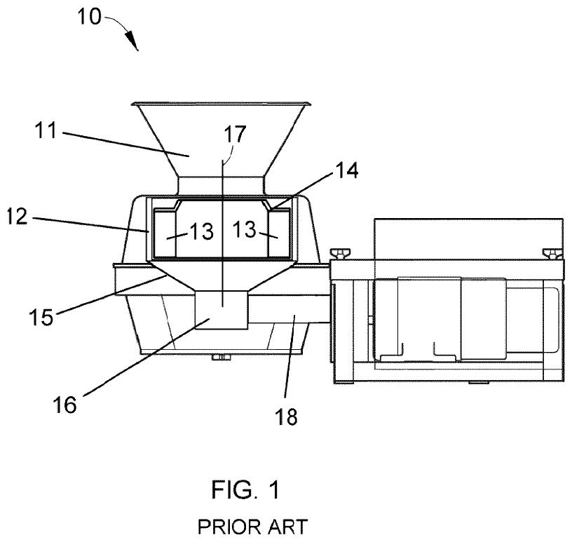

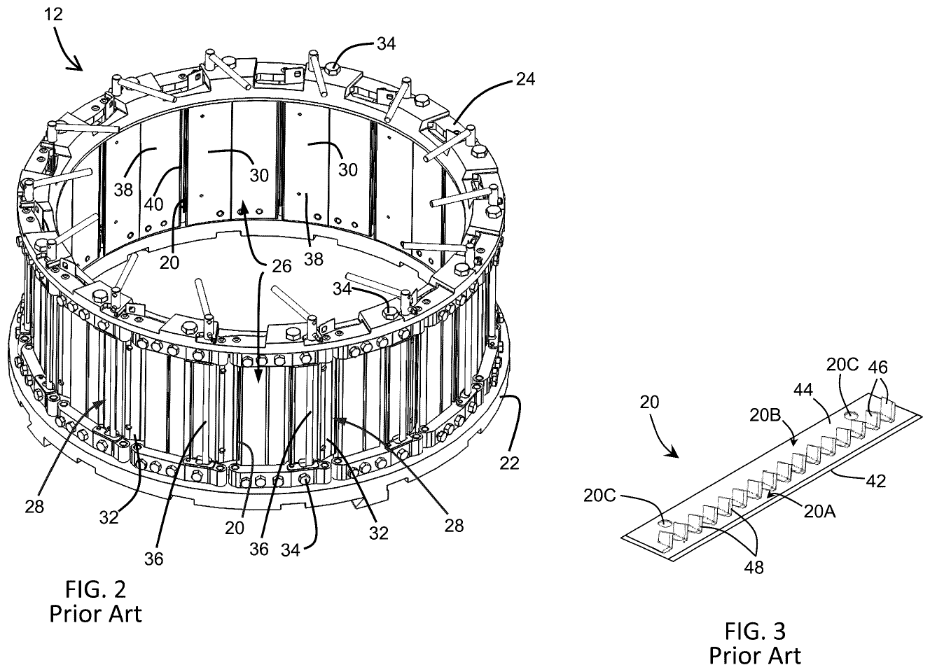

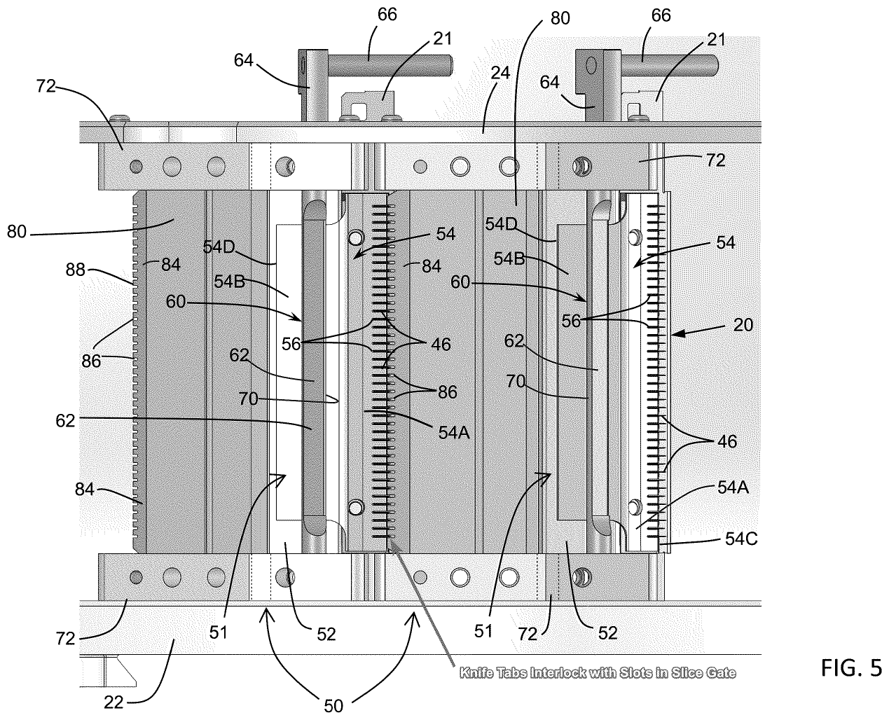

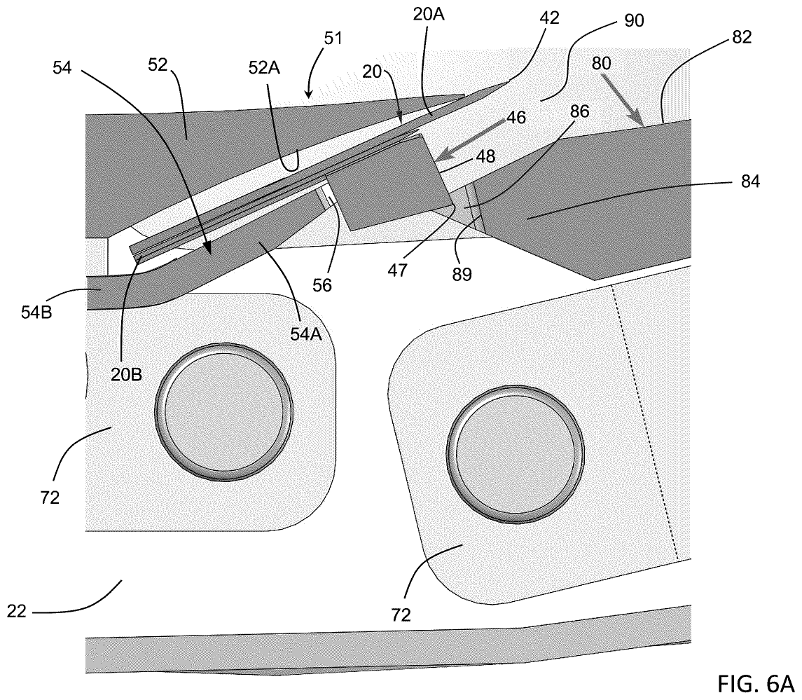

FIGS. 4 through 5 schematically represent fragmentary views of a nonlimiting embodiment of a cutting head 12 with cutting stations 50 installed thereon. Though only two cutting stations 50 are represented in FIGS. 4 and 5 for purposes of better exposing the components of the cutting stations 50, it should be understood that the cutting head 12 is typically equipped with more cutting stations 50, for example, such as the arrangement of cutting stations 26 represented in FIG. 2. In some instances, a cutting station 50 as disclosed herein may serve as a replacement or modification of cutting stations for machines and cutting heads of the type represented in FIGS. 1 and 2. As a matter of convenience, the cutting stations 50 will be illustrated and described hereinafter in reference to the slicing machine 10 of FIG. 1 equipped with an annular-shaped cutting head 12 as described in reference to FIG. 2. As such, the following discussion will focus primarily on certain aspects of the cutting stations 50 that will be described in reference to certain aspects of the machine 10 and cutting head 12 represented in FIGS. 1 and 2, whereas other aspects of the machine 10 and cutting head 12 not discussed in any detail below may be essentially as was described in reference to FIGS. 1 and 2. However, it will be appreciated that the teachings of the invention are also generally applicable to other types of cutting machines. Moreover, though such machines and cutting heads are particularly well suited for slicing food products, it is within the scope of the invention that cutting stations 50 described herein could be utilized in machines and cutting heads adapted to cut a wide variety of other types of materials.

To facilitate the description provided below of the cutting stations 50 represented in the drawings, relative terms may be used in reference to the orientation of the cutting stations 50 relative to the cutting head 12 of FIG. 2, as represented by the cutting head 12 and impeller 14 of the machine 10 represented in FIG. 1. On the basis of the coaxial arrangement of the cutting head 12 and impeller 14 in FIG. 1, relative terms including but not limited to Aaxial, @ Acircumferential, @ Aradial, @ etc., and related forms thereof may also be used below to describe the nonlimiting embodiments represented in the drawings. All such relative terms are useful to describe the cutting stations 50 depicted in FIGS. 4 through 6, but should not be otherwise interpreted as limiting the scope of the invention. Furthermore, as used herein, “leading” (and related forms thereof) refers to a position or direction on the cutting head 12 that is ahead of or precedes another in the direction of rotation of the impeller 14 when assembled with and rotating within a cutting head 12, whereas “trailing” (and related forms thereof) refers to a position or direction on the cutting head 12 that follows or succeeds another relative to the direction of rotation of the impeller 14.

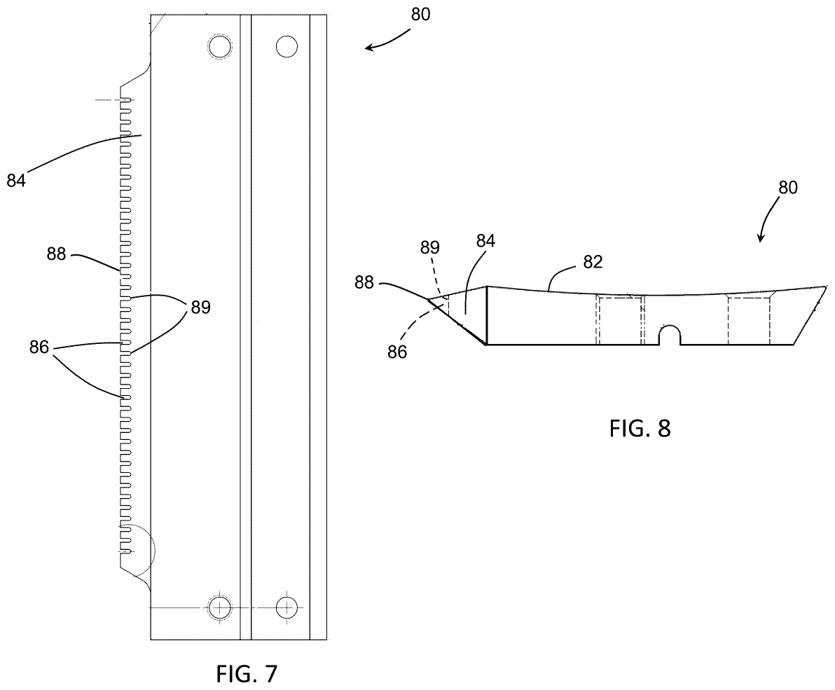

For convenience, consistent reference numbers are used throughout FIGS. 5 through 8 to identify the same or functionally related/equivalent elements of the various embodiments of cutting stations represented in the drawings.

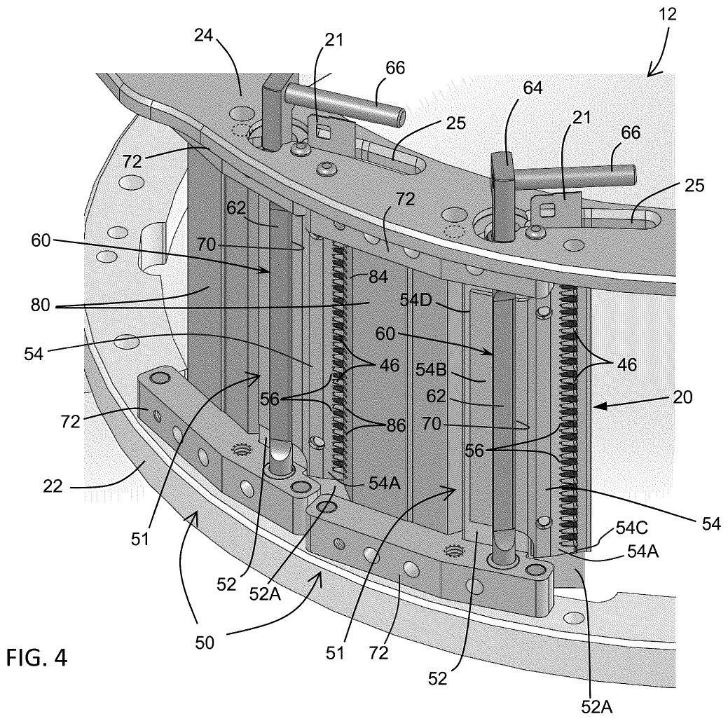

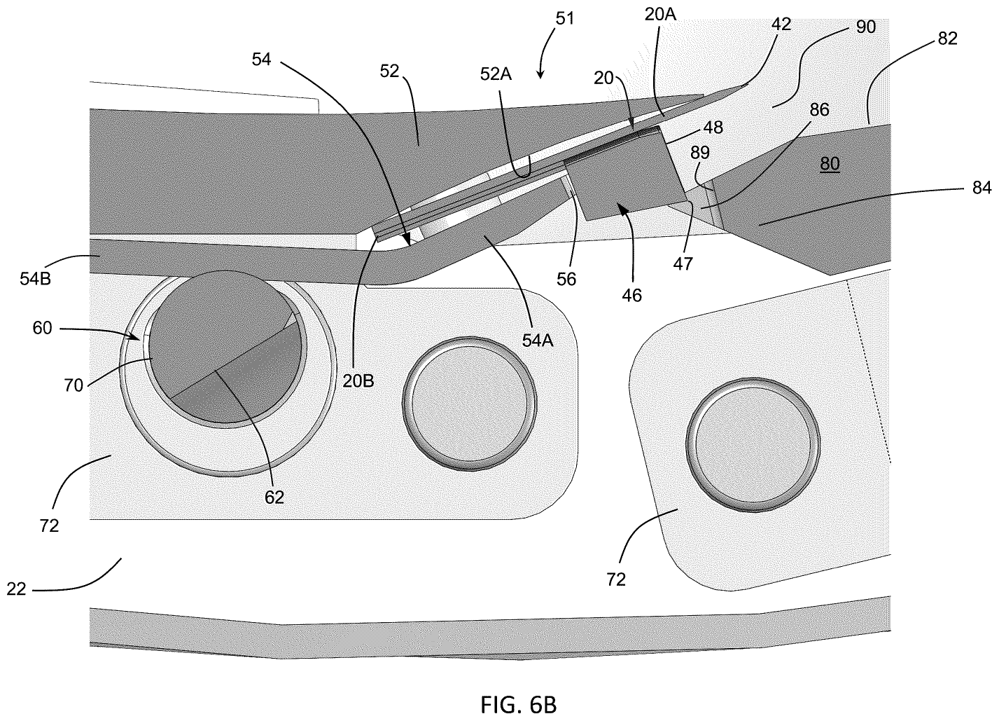

FIGS. 4 and 5 are, respectively, fragmentary perspective and side views of two cutting stations 50 mounted to a cutting head 12 of a slicing machine 10. The cutting stations 50 are each represented as comprising a clamping assembly 51, with each clamping assembly 51 comprising a knife holder 52 (partially hidden from view) and a clamp 54 securing a strip-cut knife 20 on a surface 52A (FIGS. 6A and 6B) of the knife holder 52. As a nonlimiting example, the knife 20 represented in FIGS. 4 through 6 is a two-piece strip-cut knife 20 such as shown in FIG. 3, but with the addition of a handle 21 that protrudes through an opening 25 in the upper support ring 24. As shown in FIGS. 6A and 6B and described in reference to FIG. 3, the strip-cut knife 20 is an assembly that comprises a flat (planar) slicing knife 20A that defines a cutting edge 42, and a second knife 20B (referred to herein as a julienne or strip knife) that has a flat base 44 and individual julienne tab blades 46 that are oriented roughly perpendicular to the base 44 and, when the slicing knife 20A and strip knife 20B are assembled as shown, are oriented roughly perpendicular to the cutting edge 42 of the slicing knife 20A to produce strip-cut (julienne-cut) flat food products. The tab blades 46 are represented as set back from the cutting edge 42 of the slicing knife 20A, with each tab blade 46 defining a cutting edge 48. As an alternative to the two-piece knife 20 shown, the strip-cut knife 20 could be configured as a handleless knife, such as the handleless two-piece knife 20 of FIG. 3, or as a one-piece knife 20 (with or without a handle) in which the tab blades 46 and cutting edge 42 are formed on a unitary knife.

Each cutting station 50 is further represented as mounted by and between a pair of bases 72 mounted to the support rings 22 and 24 of the cutting head 12. Each clamp 54 includes a knife-engaging portion 54A that forms a leading edge 54C of the clamp 54, physically contacts the knife 20, and therefore has a shape that is complementary to the knife 20 at least to the extent that the knife-engaging portion 54A has slots 56 that receive the tab blades 46 of the knife 20. The clamp 54 further includes a base portion 54B adjacent a trailing edge 54D of the clamp 54 and configured to be engaged by means adapted to secure the clamp 54 to the knife holder 52 and apply a clamping load to the clamp 54. As evident from FIGS. 4 and 5, the base portion 54B has a width in a direction parallel to a longitudinal direction or length of the clamp 54 (generally parallel to the leading edge 54C of the clamp 54) that is less than the width of the knife-engaging portion 54A in a direction parallel to the longitudinal direction of the clamp 54.

In FIGS. 4, 5, and 6B, the securing/clamping means for the clamp 54 is represented as an eccentric cam rod 60 configured as a quick-clamping feature that applies a clamping force to the clamp 54. The cam rod 60 is represented in FIGS. 4 and 5 as rotatably mounted between the bases 72 of the cutting head 12 so as to be rotatable about a center longitudinal axis of the cam rod 60 that passes through the ends of the cam rod 60 that are received in the bases 72. FIGS. 4 and 5 further depict an upper end 64 of the rod 60 as protruding through the upper support ring 24. In the nonlimiting embodiment shown, counterclockwise rotation of the cam rod 60 about its axis (as viewed from above in FIGS. 4 and 5) using a handle 66 of the rod 60 causes the cam rod 60 to eccentrically move into engagement with the base portion 54B of the clamp 54, forcing the clamp 54 into engagement with the knife 20 and thereby clamping the knife 20 to the knife holder 52. This position, depicted in FIGS. 4, 5, and 6B, is referred to herein as a locked or clamping position. The force applied to the clamp 54 by the cam rod 60 can be released by rotating the cam rod 60 counterclockwise about its axis to an unlocked or open position. Such an open position, also referred to herein as a knife release position, is represented in FIG. 6A and is preferably operable to enable the knife 20 to be installed in and removed from the cutting head 12. For example, the strip-cut knife 20 can be removed from the cutting station 50 by grasping the handle 21 of the knife 20 and withdrawing the knife 20 upward through the opening 25 in the upper support ring 24. In the case of a knife 20 that lacks a handle, rotating the cam rod 60 to its open position preferably enables the clamp 54 and the knife 20 to be removable together from and installable together in the cutting station 50.

As seen in FIGS. 4, 5, and 6B, the cam rod 60 defines a camming surface 70 that, when the cam rod 60 is rotated to the clamping position shown in FIGS. 4, 5, and 6B, engages the base portion 54B of the clamp 54 to force the clamp 54 into engagement with the knife 20 and clamp the knife 20 (through the clamp 54) against the knife holder 52. As further represented in FIGS. 4, 5, and 6B, the cam rod 60 has a radial concavity 62 that defines a recessed surface spanning a portion (as shown, a majority) of the longitudinal length of the rod 60 between the bases 72. As portrayed in FIGS. 4, 5, and 6B, the radial concavity 62 of the cam rod 60 faces away from the clamp 54 when the cam rod 60 has been rotated about its axis so that the camming surface 70 engages the clamp 54. The radial concavity 62 of the rod 60 is sized to accommodate the base portion 54B of the clamp 54, whose width is also parallel to the cam rod 60 and less than the longitudinal length of the cavity 62 such that the base portion 54B of the clamp 54 is able to be loosely received within the radial concavity 62 when the cam rod 60 is rotated about its axis so that the radial concavity 62 faces the clamp 54. Whereas FIGS. 4, 5, and 6B represent the rotational position of the cam rod 60 that effectuates the clamping position, FIG. 6A represents the effect of the rotational position of the cam rod 60 (not shown) that effectuates the knife release position in which the radial concavity 62 of the cam rod 60 is oriented to largely face the clamp 54 and the camming surface 70 largely faces away from the clamp 54. The eccentricity of the cam rod 60 and the location of its concavity 62 combine to release the knife 20 from the knife holder 52 so that the knife 20 can be removed from the cutting head 12 by grasping the handle 21 of the knife 20 and withdrawing the knife 20 upward through the opening 25 in the upper support ring 24.

In addition to each cutting station 50 comprising a clamping assembly 51 (each comprising a strip-cut knife 20, knife holder 52, clamp 54, and cam rod 60), each cutting station 50 shown in FIGS. 4, 5, and 6 further includes a gate 80 located in a leading position relative to the knife 20 of the immediately trailing cutting station 50 so that a product to be sliced by the knife 20 first slides across an inward-facing surface 82 of the gate 80 prior to encountering the knife 20. Together, the cutting edge 42 of a knife 20 and a trailing end 84 of the preceding gate 80 define a gate opening 90 that determines the thickness of a slice produced by the slicing knife 20A.

FIGS. 4 through 8 depict the trailing end 84 of the gate 80 as tapering in its thickness toward its distal edge and having gate slots 86 defined within at least a distal portion of the trailing end 84. FIGS. 4, 5, and 6 depict each tab blade 46 of the knife 20 as received in a corresponding one of the gate slots 86. The gate slots 86 are perpendicular to the cutting edge 42 of the knife 20, parallel to the tab blades 46, and preferably wider that the thicknesses of the tab blades 46 received therein to facilitate assembly and positioning of the knife 20 and its tab blades 46 on the knife holder 52 in the knife release position (shown in FIG. 6A) as well as ensure that the trailing end 84 of the gate 80 does not cause the tab blades 46 to deflect as the cam rod 60 is rotated to the clamping position of FIGS. 4, 5, and 6B. The length of each gate slot 86 (i.e., the distance that the slot 86 extends into the gate 80 from the trailing edge 88 of the gate 80 to the base or root 89 of the slot 86) is also provided to ensure that the cutting edge 48 of a tab blade 46 does not contact, but is in proximity, to the root 89 of the slot 86 with the clamping assembly 51 in the clamping position of FIGS. 4, 5, and 6B. FIGS. 6A and 6B represent the leading tips 47 the tab blades 46 (one of which is visible) as entirely disposed within their respective slots 86, the tab blades 46 as occupying less than 50% of the length of their respective slots 86, and occupying less than 25%, e.g., about 10%, of the area of their respective slots 86 (as measured between the trailing edge 88 and root 89).

By placing the tab blades 46 within the slots 96 formed in the trailing end 84 of the leading gate 80, completeness of the strip cuts performed with the tab blades 46 can be assured when processing certain food products that are difficult to cut into strips at high production rates. Though the widths and lengths of the gate slots 86 can be adapted for particular tab blades 46, in one nonlimiting example product was sliced and cut into strips having widths of about 2.4 mm with gates 80 whose gate slots 86 had widths of about 0.8 mm and lengths of about 2.3 mm.

As previously noted above, though the foregoing detailed description describes certain aspects of one or more particular embodiments of the invention, alternatives could be adopted by one skilled in the art. For example, the cutting stations 50 and cutting heads and machines in which they may be installed or used could differ in appearance and construction from what is shown in the drawings. Also, the cutting stations 50 could be used with knives that differ from what is shown in the drawings, for example, in terms of shape (flat or shaped) and, in the case of shaped knives, amplitude (distance from valley to peak) and/or pitch (distance between peaks). Furthermore, various materials and processes could be used in the manufacture of the cutting stations 50 and their components. As such, and again as was previously noted, it should be understood that the invention is not necessarily limited to any particular embodiment described herein or illustrated in the drawings.

1. A cutting station for a slicing machine, the cutting station comprising:
a knife holder having a surface and a leading edge;
a strip-cut knife supported on the surface of the knife holder, the strip-cut knife having a cutting edge that protrudes from the leading edge of the knife holder and tab blades that are oriented perpendicular to the cutting edge of the strip-cut knife;
a clamp arranged relative to the knife holder and knife to clamp the knife to the knife holder, the clamp having a leading edge, a trailing edge, a knife-engaging portion adjacent the leading edge of the clamp, and a base portion adjacent the trailing edge of the clamp, at least part of the knife-engaging portion having a shape complementary to the knife;
a gate disposed in proximity of the knife holder and the cutting edge of the strip-cut knife, the gate having a trailing end that, with the cutting edge of strip-cut knife, defines a gate opening that determines the thickness of a slice produced by the cutting station, the trailing end of the gate having gate slots defined therein in which the tab blades are received; and
means for applying a clamping load to the clamp to secure the knife to the knife holder.

2. The cutting station of claim 1, wherein the gate slots are perpendicular to the cutting edge of the strip-cut knife, parallel to the tab blades, and wider than the thicknesses of the tab blades received therein.

3. The cutting station of claim 1, wherein the trailing end of the gate tapers in thickness toward a distal edge of the gate and the gate slots are defined within at least a distal portion of the trailing end.

4. The cutting station of claim 1, wherein the knife-engaging portion of the clamp comprises slots in which the tab blades of the strip-cut knife are received.

5. The cutting station of claim 1, wherein the means for applying the clamping load to the clamp comprises a cam rod, the cam rod being rotatable about a longitudinal axis thereof, the cam rod having a longitudinal length, a camming surface that engages the base portion of the clamp when the cam rod is rotated to a clamping position to force the clamp into engagement with the knife and clamp the knife against the knife holder, the cam rod having a radial concavity that has a longitudinal length and defines a recessed surface spanning at least a portion of the longitudinal length of the cam rod, the radial concavity being sized to accommodate the base portion of the clamp, the width of the base portion being less than the longitudinal length of the radial concavity such that the base portion of the clamp is loosely received within the radial concavity when the cam rod is rotated so that the radial concavity faces the clamp in an open position thereof.

6. The cutting station of claim 5, wherein the strip-cut knife is removable from and installable in the cutting station when the cam rod is rotated to the open position.

7. The cutting station of claim 6, wherein the clamp and the knife are removable together from and installable together in the cutting station when the cam rod is rotated to the open position.

8. The cutting station of claim 1, wherein the strip-cut knife is an assembly that comprises a slicing knife that defines the cutting edge, and a second knife that has a flat base and individual tab blades that are oriented roughly perpendicular to the base, the slicing knife and the second knife being assembled so that the tab blades are oriented perpendicular to the cutting edge of the slicing knife to produce strip-cut products.

9. The cutting station of claim 1, wherein the strip-cut knife is a one-piece knife in which the tab blades and the cutting edge are formed on a unitary knife.

10. A slicing machine equipped with the cutting station of claim 1.

11. A method of operating the slicing machine of claim 10, wherein the tab blades received in the gate slots of the gate promote complete strip cuts in food products that are difficult to cut into strips at high production rates.
